(19) United States
(12) Patent Application Publication
(10) Pub. No.: US 2009/0094067 A1
(43) Pub. Date: Apr. 9, 2009

(54) Systems and methods for company internal optimization utilizing epigenetic data

(75) Inventors: Edward K.Y. Jung, Bellevue, WA (US); Roderick A. Hyde, Redmond, WA (US); Jordin T. Kare, Seattle, WA (US); Eric C. Leuthardt, St. Louis, MO (US); Dennis J. Rivet, Portsmouth, VA (US); Lowell L. Wood, JR., Bellevue, WA (US)

Correspondence Address: IV - SUITER SWANTZ PC LLO, 14301 FNB PARKWAY , SUITE 220, OMAHA, NE, 68154, US

(73) Assignees: Searete LLC, a limited liability corporation of; the state of Delaware

(21) Appl. No.: 12/012,701

(22) Filed: Feb. 5, 2008

Related U.S. Application Data
(63) Continuation-in-part of application No. 11/906,995, filed on Oct. 4, 2007.
Application No. 11/906,995 is a continuation-in-part of application No. 11/974,166, filed on Oct. 11, 2007.
Application No. 11/974,166 is a continuation-in-part of application No. 11/986,967, filed on Nov. 27, 2007.
Application No. 11/986,967 is a continuation-in-part of application No. 11/986,986, filed on Nov. 27, 2007.
Application No. 11/986,986 is a continuation-in-part of application No. 11/986,966, filed on Nov. 27, 2007.
Application No. 11/986,966 is a continuation-in-part of application No. 12/004,098, filed on Dec. 19, 2007.
Application No. 12/004,098 is a continuation-in-part of application No. 12/006,249, filed on Dec. 31, 2007.

(51) Int. Cl. G06Q 10/00; G06Q 40/00

(52) U.S. Cl. 705/4; 705/7

(57) ABSTRACT

A method includes receiving epigenetic information associated with at least a first individual and/or assessing at least one corporate liability at least partially based on the epigenetic information associated with at Least a first individual.

A system includes means for receiving epigenetic information associated with at Least a first individual and/or means for assessing at least one corporate liability at least partially based on the epigenetic information associated with at least a first individual.

A system includes circuitry for receiving epigenetic information associated with at least a first individual and/or circuitry for assessing at least one corporate liability at least partially based on the epigenetic information associated with at least a first individual.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC § 119(e) for provisional patent applications, for any and all parent, grandparent, great-grandparent, etc. applications of the Related Application(s)).

### RELATED APPLICATIONS

For purposes of the USPTO extra-statutory requirements, the present application constitutes a continuation-in-part of U.S. patent application Ser. No. 11/906,995, entitled SYSTEMS AND METHODS FOR UNDERWRITING RISKS UTILIZING EPIGENETIC INFORMATION, naming Roderick A. Hyde, Jordin T. Kare, Eric C. Leuthardt, Dennis J. Rivet, Michael A. Smith; and Lowell L. Wood, Jr. as inventors, filed Oct. 4, 2007, which is currently co-pending, or is an application of which a currently co-pending application is entitled to the benefit of the filing date.
For purposes of the USPTO extra-statutory requirements, the present application constitutes a continuation-in-part of U.S. patent application Ser. No. 11/974,166, entitled SYSTEMS AND METHODS FOR UNDERWRITING RISKS UTILIZING EPIGENETIC INFORMATION, naming Roderick A. Hyde, Jordin T. Kare, Eric C. Leuthardt, Dennis J. Rivet, Michael A. Smith; and Lowell L. Wood, Jr. as inventors, filed Oct. 11, 2007, which is currently co-pending, or is an application of which a currently co-pending application is entitled to the benefit of the filing date.
For purposes of the USPTO extra-statutory requirements, the present application constitutes a continuation-in-part of U.S. patent application Ser. No. 11/986,967, entitled SYSTEMS AND METHODS FOR ANONYMIZING PERSONALLY IDENTIFIABLE INFORMATION ASSOCIATED WITH EPIGENETIC INFORMATION, naming Roderick A. Hyde, Jordin T. Kare, Eric C. Leuthardt, Dennis J. Rivet, Michael A. Smith; and Lowell L. Wood, Jr. as inventors, filed Nov. 27, 2007, which is currently co-pending, or is an application of which a currently co-pending application is entitled to the benefit of the filing date.
For purposes of the USPTO extra-statutory requirements, the present application constitutes a continuation-in-part of U.S. patent application Ser. No. 11/986,986, entitled SYSTEMS AND METHODS FOR TRANSFERRING COMBINED EPIGENETIC INFORMATION AND OTHER INFORMATION, naming Roderick A. Hyde, Jordin T. Kare, Eric C. Leuthardt, Dennis J. Rivet, Michael A. Smith; and Lowell L. Wood, Jr. as inventors, filed Nov. 27, 2007, which is currently co-pending, or is an application of which a currently co-pending application is entitled to the benefit of the filing date.
For purposes of the USPTO extra-statutory requirements, the present application constitutes a continuation-in-part of U.S. patent application Ser. No. 11/986,966, entitled SYSTEMS AND METHODS FOR REINSURANCE UTILIZING EPIGENETIC INFORMATION, naming Roderick A. Hyde, Jordin T. Kare, Eric C. Leuthardt, Dennis J. Rivet, Michael A. Smith; and Lowell L. Wood, Jr. as inventors, filed Nov. 27, 2007, which is currently co-pending, or is an application of which a currently co-pending application is entitled to the benefit of the filing date.
For purposes of the USPTO extra-statutory requirements, the present application constitutes a continuation-in-part of U.S. patent application Ser. No. 12/004,098, entitled SYSTEMS AND METHODS FOR CORRELATING EPIGENETIC INFORMATION WITH DISABILITY DATA, naming Roderick A. Hyde, Jordin T. Kare, Eric C. Leuthardt, Dennis J. Rivet; and Lowell L. Wood, Jr. as inventors, filed Dec. 19, 2007, which is currently co-pending, or is an application of which a currently co-pending application is entitled to the benefit of the filing date.
For purposes of the USPTO extra-statutory requirements, the present application constitutes a continuation-in-part of U.S. patent application Ser. No. 12/006,249, entitled SYSTEMS AND METHODS FOR CORRELATING PAST EPIGENETIC INFORMATION WITH PAST DISABILITY DATA, naming Roderick A. Hyde, Jordin T. Kare, Eric C. Leuthardt, Dennis J. Rivet; and Lowell L. Wood, Jr. as inventors, filed Dec. 31, 2007, which is currently co-pending, or is an application of which a currently co-pending application is entitled to the benefit of the filing date.

The United States Patent Office (USPTO) has published a notice to the effect that the USPTO's computer programs require that patent applicants reference both a serial number and indicate whether an application is a continuation or continuation-in-part. Stephen G. Kunin, Benefit of Prior-Filed Application, USPTO Official Gazette Mar. 18, 2003, available at http://www.uspto.pov/web/offices/com/sol/og/2003/week11/patbene.htm. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant is designating the present application as a continuation-in-part of its parent applications as set forth above, but expressly points out that such designations are not to be construed in any way as any type of commentary and/or admission as to whether or not the present application contains any new matter in addition to the matter of its parent application(s).

All subject matter of the Related Applications and of any and all parent, grandparent, great-grandparent, etc. applications of the Related Applications is incorporated herein by reference to the extent such subject matter is not inconsistent herewith.

### SUMMARY

A method includes receiving epigenetic information associated with at least a first individual and/or assessing at least one corporate liability at least partially based on the epigenetic information associated with at least a first individual. In addition to the foregoing, other method aspects are described in the claims, drawings, and text forming a part of the present disclosure.

In one or more various aspects, related systems include but are not limited to circuitry and/or programming for effecting the herein-referenced method aspects; the circuitry and/or programming can be virtually any combination of hardware, software, and/or firmware configured to effect the herein-referenced method aspects depending upon the design choices of the system designer.

A system includes means for receiving epigenetic information associated with at least a first individual and/or means for assessing at least one corporate liability at least partially based on the epigenetic information associated with at least a first individual. In addition to the foregoing, other method aspects are described in the claims, drawings, and text forming a part of the present disclosure.

A system includes circuitry for receiving epigenetic information associated with at least a first individual and/or circuitry for assessing at least one corporate liability at least partially based on the epigenetic information associated with at least a first individual. In addition to the foregoing, other method aspects are described in the claims, drawings, and text forming a part of the present disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 illustrates an exemplary environment in which one or more technologies may be implemented.

FIG. 2 illustrates an operational flow representing example operations related to assessing at least one corporate liability at least partially based on the epigenetic information associated with at least a first individual.

FIG. 3 illustrates an alternative embodiment of the operational flow of FIG. 2.

FIG. 4 illustrates an alternative embodiment of the operational flow of FIG. 2.

FIG. 5 illustrates an alternative embodiment of the operational flow of FIG. 2.

FIG. 6 illustrates an alternative embodiment of the operational flow of FIG. 2.

FIG. 7 illustrates an alternative embodiment of the operational flow of FIG. 2.

FIG. 8 illustrates an alternative embodiment of the operational flow of FIG. 2.

FIG. 9 illustrates an alternative embodiment of the operational flow of FIG. 2.

FIG. 10 illustrates an alternative embodiment of the operational flow of FIG. 2.

FIG. 11 illustrates an alternative embodiment of the operational flow of FIG. 2.

FIG. 12 illustrates an alternative embodiment of the operational flow of FIG. 2.

FIG. 13 illustrates an alternative embodiment of the operational flow of FIG. 2.

FIG. 14 illustrates an alternative embodiment of the operational flow of FIG. 2.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be Limiting. Other embodiments may be utilized, and other changes may be made, without departing from the spirit or scope of the subject matter presented here.

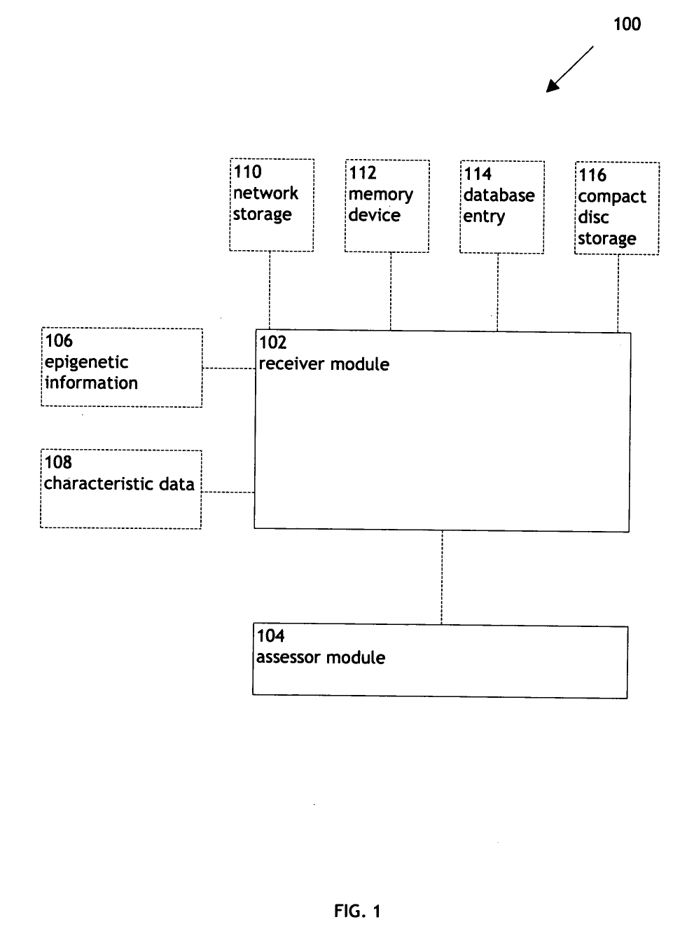

Referring to FIG. 1, a system 100 for receiving epigenetic information associated with at least a first individual and/or assessing at least one corporate liability at least partially based on the epigenetic information associated with at least a first individual is illustrated. The system 100 may include receiver module 102 and/or assessor module 104. Receiver module 102 may receive epigenetic information 106 and/or characteristic data 108 from network storage 110, memory device 112, database entry 114, and/or compact disc storage 116. System 100 generally represents instrumentality for receiving epigenetic information associated with at least a first individual and/or assessing at least one corporate liability at least partially based on the epigenetic information associated with at least a first individual. The steps of receiving epigenetic information associated with at least a first individual and/or assessing at least one corporate liability at least partially based on the epigenetic information associated with at least a first individual may be accomplished electronically, such as with a set of interconnected electrical components, an integrated circuit, and/or a computer processor.

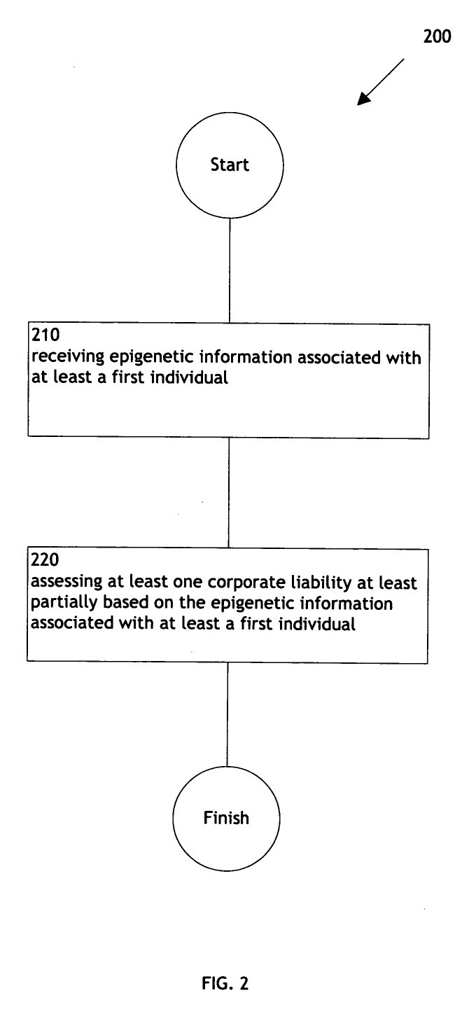

FIG. 2 illustrates an operational flow 200 representing example operations related to receiving epigenetic information associated with at least a first individual and/or assessing at least one corporate liability at least partially based on the epigenetic information associated with at least a first individual. In FIG. 2 and in following figures that include various examples of operational flows, discussion and explanation may be provided with respect to the above-described examples of FIG. 1, and/or with respect to other examples and contexts. However, it should be understood that the operational flows may be executed in a number of other environments and contexts, and/or in modified versions of FIG. 1. Also, although the various operational flows are presented in the sequence(s) illustrated, it should be understood that the various operations may be performed in other orders than those which are illustrated, or may be performed concurrently.

After a start operation, the operational flow 200 shows operation 210, which depicts receiving epigenetic information associated with at least a first individual. For example, as shown in FIG. 1, receiver module 102 may receive epigenetic information associated with at least a first individual. In a specific instance, receiver module 102 receives epigenetic information from network storage 110 indicating a likelihood of lung cancer for a group of one hundred individuals residing in the same city. A first individual may include individual persons and/or single entities. In some instances, receiver module 102 may include a computer processor. Some explanation regarding epigenetic information 106 may be found in sources such as Bird, Perceptions of Epigenetics, NATURE 477, 396-398 (2007); Grewal and Elgin, Transcription and RNA Interference in the Formation of Heterochromatin, NATURE 447: 399-406 (2007); and Callinan and Feinberg, The Emerging Science of Epigenomics, HUMAN MOLECULAR GENETICS 15, R95-R11 (2006), each of which are incorporated herein by reference. Epigenetic information may include, for example, information regarding DNA methylation, histone states or modifications, transcriptional activity, RNAi, protein binding or other molecular states. Further, epigenetic information may include information regarding inflammation-mediated cytosine damage products. See, e.g., Valinluck and Sowers, Inflammation-Mediated Cytosine Damage: A Mechanistic Link Between Inflammation and the Epigenetic Alterations in Human Cancers, CANCER RESEARCH 67: 5583-5586 (2007), which is incorporated herein by reference. Any proper nouns and/or names used herein are meant to be exemplary only.

Then, operation 220 depicts assessing at least one corporate liability at least partially based on the epigenetic information associated with at least a first individual. For example, as shown in FIG. 1, assessor module 104 may assess at least one corporate liability at least partially based on the epigenetic information associated with at least a first individual. In one specific instance, assessor module 104 evaluates at least one corporate liability including a set of pension plans at least partially based on epigenetic information indicating a likelihood of diabetes with the epigenetic information associated with an individual named John Smith. A corporate liability may include a pension, a retirement plan, a Legacy cost, and/or a health care plan. In some instances, assessor module 104 may include a computer processor.

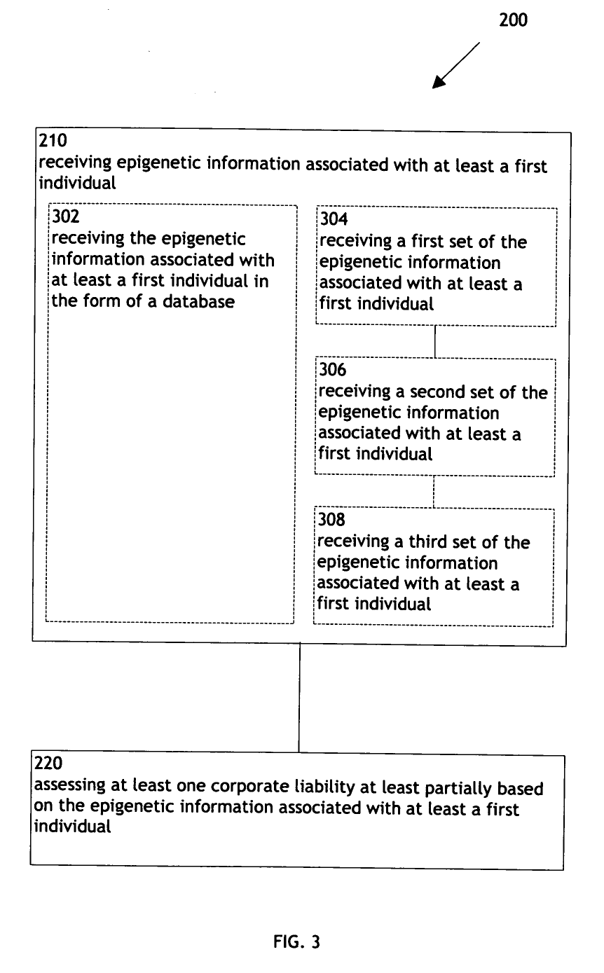

FIG. 3 illustrates alternative embodiments of the example operational flow 200 of FIG. 2. FIG. 3 illustrates example embodiments where the receiving epigenetic information associated with at least a first individual operation 210 may include at least one additional operation. Additional operations may include an operation 302, an operation 304, an operation 306, and/or an operation 308.

Operation 302 illustrates receiving the epigenetic information associated with at Least a first individual in the form of a database. For example, as shown in FIG. 1, receiver module 102 may receive the epigenetic information associated with at least a first individual in the form of a database. In one example, receiver module 102 receives epigenetic information indicating a specific histone modification associated with a first individual named Robert White in the form of a database from memory device 112. A database may include a collection of data organized for convenient access. The database may include information digitally stored in a memory device 112, as at least a portion of at least one database entry 114, in compact disc storage 116, and/or in network storage 110. In some instances, a database may include information stored non-digitally such as at least a portion of a book, a paper file, and/or a non-computerized index and/or catalog. Non-computerized information may be received by receiver module 102 by scanning or manually entering the information into a digital format.

Operation 304 illustrates receiving a first set of the epigenetic information associated with at least a first individual. For example, as shown in FIG. 1, receiver module 102 may receive a first set of the epigenetic information associated with at least a first individual. In a specific example, receiver module 102 receives from database entry 114 a first set of epigenetic information indicating a likelihood of skin cancer associated with a group of one thousand individuals residing in Phoenix, Ariz. A set of information may include a set amount of information and both terms may be used interchangeably herein. Further, a set of information may include batch, finite, and/or discrete amounts of information. Operation 306 illustrates receiving a second set of the epigenetic information associated with at least a first individual. For example, as shown in FIG. 1, receiver module 102 may receive a second set of the epigenetic information associated with at least a first individual. In a specific example and continuing with the previous example, receiver module 102 receives from database entry 114 a second set of epigenetic information indicating a likelihood of skin cancer associated with a group of one thousand individuals residing in Phoenix, Ariz. Further, operation 308 illustrates receiving a third set of the epigenetic information associated with at least a first individual. For example, as shown in FIG. 1, receiver module 102 may receive a third set of the epigenetic information associated with at least a first individual. In one instance, continuing with the previous example, receiver module 102 receives from database entry 114 a third set of epigenetic information indicating a likelihood of skin cancer associated with a group of one thousand individuals residing in Phoenix, Ariz. In some examples, receiver module 102 may include a computer processor. Additional sets of information may be received by receiver module 102 as batches or finite sets beyond the first, second, and third set of epigenetic information.

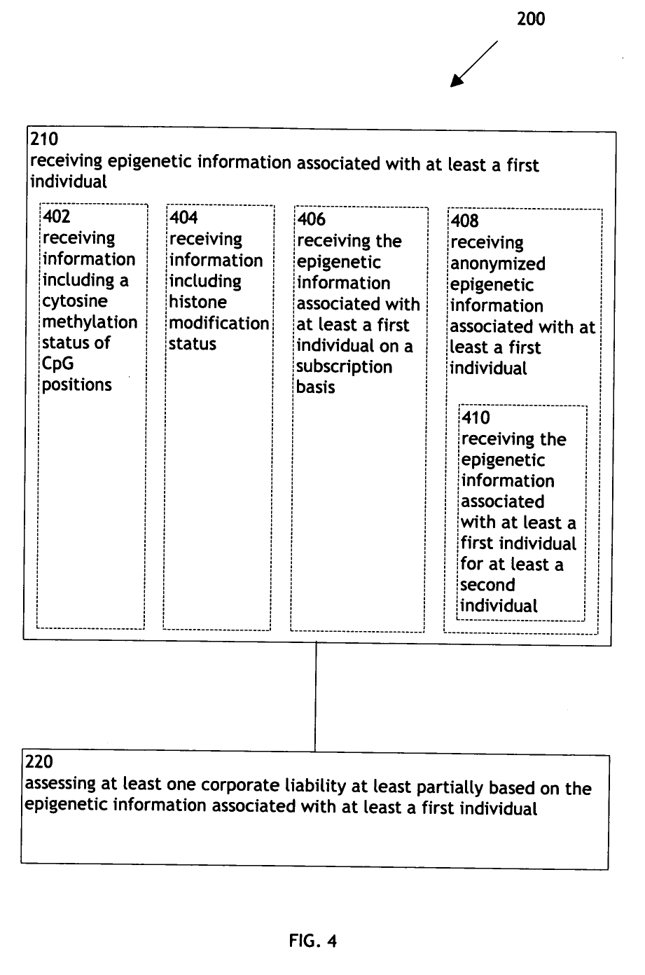

FIG. 4 illustrates alternative embodiments of the example operational flow 200 of FIG. 2. FIG. 4 illustrates example embodiments where the receiving epigenetic information associated with at least a first individual operation 210 may include at least one additional operation. Additional operations may include an operation 402, an operation 404, an operation 406, an operation 408, and/or an operation 410.

Operation 402 illustrates receiving information including a cytosine methylation status of CpG positions. For example, as shown in FIG. 1, receiver module 102 may receive information including a cytosine methylation status of CpG positions. In one instance, receiver module 102 receives epigenetic information including a cytosine methylation status of CpG positions from network storage 110. DNA methylation and cytosine methylation status of CpG positions for an individual may include information regarding the methylation status of DNA generally or in the aggregate, or information regarding DNA methylation at one or more specific DNA loci, DNA regions, or DNA bases. See, for example: Shilatifard, Chromatin modifications by methylation and ubiquitination: implications in the regulation of gene expression, ANNUAL REVIEW OF BIOCHEMISTRY, 75:243-269 (2006); and Zhu and Yao, Use of DNA methylation for cancer detection and molecular classification, JOURNAL OF BIOCHEMISTRY AND MOLECULAR BIOLOGY, 40:135-141 (2007), each of which are incorporated herein by reference. In some instances, receiver module 102 may include a computer processor.

Operation 404 illustrates receiving information including histone modification status. For example, as shown in FIG. 1, receiver module 102 may receive information including histone modification status. In one specific example, receiver module 102 receives epigenetic information including a histone modification status for a group of individuals from memory device 112. Information regarding histone structure may, for example, include information regarding specific subtypes or classes of histones, such as H1, H2A, H2B, H3 or H4. Information regarding histone structure may have an origin in array-based techniques, such as described in Barski et al., High-resolution profiling of histone methylations in the human genome, CELL 129, 823-837 (2007), which is incorporated herein by reference. In some instances, receiver module 102 may include a computer processor.

Operation 406 depicts receiving the epigenetic information associated with at least a first individual on a subscription basis. For example, as shown in FIG. 1, receiver module 102 may receive the epigenetic information associated with at least a first individual on a subscription basis. In a specific example, receiver module 102 may receive epigenetic information from database entry 114 associated with a group of one hundred individuals residing in the same geographical location on a subscription basis for a period of one year. A subscription may include an agreement to receive and/or be given access to the epigenetic information. The subscription may include access to epigenetic information in a digital form and/or a physical form of information, such as paper printouts. In some instances, receiver module 102 may include a computer processor.

Operation 408 illustrates receiving anonymized epigenetic information associated with at least a first individual. For example, as shown in FIG. 1, receiver module 102 may receive anonymized epigenetic information associated with at least a first individual. In one instance, receiver module 102 receives anonymized epigenetic information from compact disc storage 116. Anonymized epigenetic information may be received for more than one individual, such as a group of two hundred individuals. Anonymized epigenetic information may be anonymized in different degrees and by different methods. Different degrees of anonymization may include full anonymization and/or partial anonymization, such as in the case of pseudonym utilization. Methods for anonymizing epigenetic information may include the use of cell suppression and/or utilizing anonymization algorithms. In some instances, receiver module 102 may include a computer processor. Operation 410 illustrates receiving the epigenetic information associated with at Least a first individual for at least a second individual. For example, as shown in FIG. 1, receiver module 102 may receive the epigenetic information associated with at least a first individual for at least a second individual. In one instance, receiver module 102 receives epigenetic information from network storage 110 indicating a specific DNA methylation associated with a first individual named William Smith for a second individual named Thomas Smith. The at least first individual and the at least a second individual may or may not have a familial and/or blood relationship. In some instances, receiver module 102 may include a computer processor.

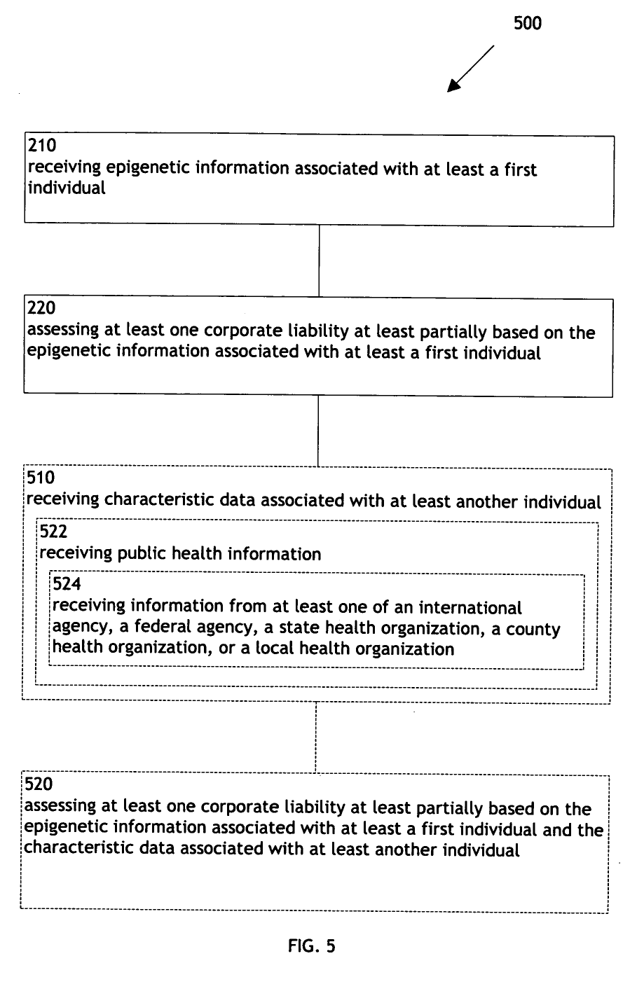

FIG. 5 illustrates an operational flow 500 representing example operations related to receiving epigenetic information associated with at least a first individual; receiving characteristic data associated with at least another individual; and assessing at least one corporate liability at least partially based on the epigenetic information associated with at least a first individual and the characteristic data associated with at least another individual. FIG. 5 illustrates an example embodiment where the example operational flow 200 of FIG. 2 may include at least one additional operation. Additional operations may include an operation 510, an operation 520, an operation 522, and/or an operation 524.

After a start operation, operation 210, and operation 220, the operational flow 500 moves to operation 510 illustrating receiving characteristic data associated with at least another individual. For example, as shown in FIG. 1, receiver module 102 may receive characteristic data associated with at least another individual. In a specific instance, receiver module 102 receives characteristic data associated with a first individual named Fred Johnson and another individual named Casey Anderson. The at least another individual may or may not include the first individual. In some instances, receiver module 102 may include a computer processor.

Then, operation 520 depicts assessing at least one corporate liability at least partially based on the epigenetic information associated with at least a first individual and the characteristic data associated with at least another individual. For example, as shown in FIG. 1, assessor module 104 may assess at least one corporate liability at least partially based on the epigenetic information associated with at least a first individual and the characteristic data associated with at least another individual. In one instance, assessor module 104 evaluates a corporate liability including a pension based on epigenetic information including specific DNA methylation sites associated with a first group of fifty individuals and characteristic data associated with a separate group of ten thousand individuals residing in the same city as the first group of fifty individuals. Characteristic data may include environmental data, financial data, habit data, consumption data, dietary data, and/or other data related to personal and/or population characteristics. In some instances, assessor module 104 may include a computer processor.

Operation 522 illustrates receiving public health information. For example, as shown in FIG. 1, receiver module 102 may receive public health information. In one specific instance, receiver module 102 receives public health information including a mortality rate for the city of Hilo, Hawaii from memory device 112. Public health data may include information regarding specific aspects of public health, including mortality rates, the occurrence of disease and/or illness, and/or the rate of visits to a health provider for a certain population, as well as other information. Further, operation 524 illustrates receiving information from at least one of an international agency, a federal agency, a state health organization, a county health organization, or a local health organization. For example, as shown in FIG. 1, receiver module 102 may receive information from at least one of an international agency, a federal agency, a state health organization, a county health organization, or a local health organization. In one instance, receiver module 102 receives information from the World Health Organization (WHO) from compact disc storage 116. Other international agencies may include the World Bank, the United Nations, the Pan American Health Organization (PAHO), the United Nations Children's Fund (UNICEF), the United Nation Development Programme (UNDP), Oxfam, and/or Project Hope, as well as other international agencies and organizations. Some federal agencies may include the United States Department for Health and Human Services (HHS), the Office of Public Health and Science, the Office of the Surgeon General, and/or the United States Department for Veterans Affairs. A state health organization may include a state sponsored organization and/or agency as well as an organization representing the health interests of multiple states. A county health organization and/or a local health organization may include a county sponsored organization, a city sponsored organization, not for profit organizations, non-governmental organization, and/or an area sponsored organization. In some instances, receiver module 102 may include a computer processor.

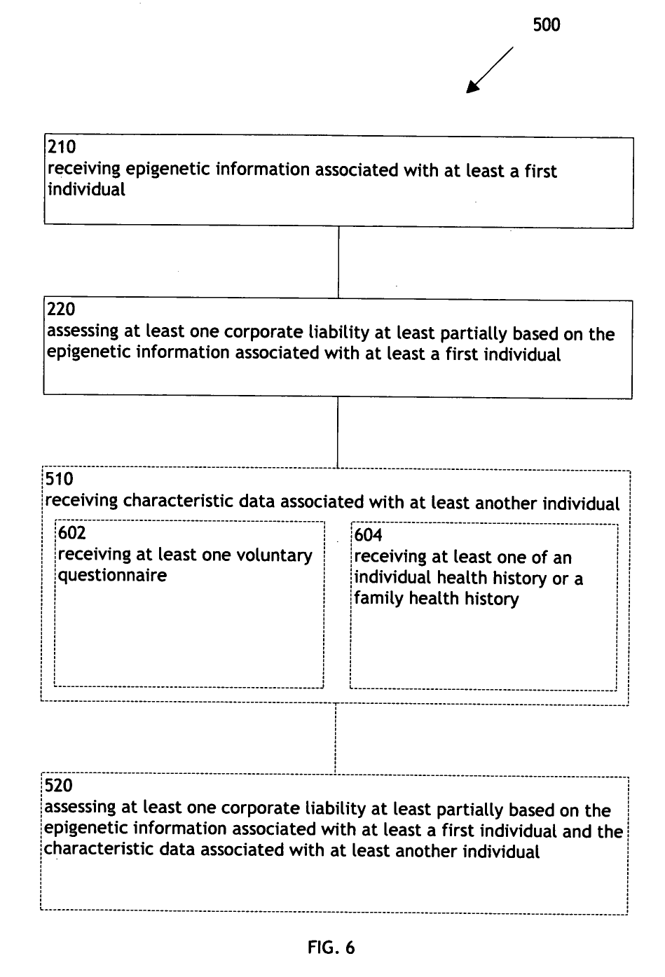

FIG. 6 illustrates alternative embodiments of the example operational flow 500 of FIG. 5. FIG. 6 illustrates example embodiments where operation 510 may include at least one additional operation. Additional operations may include an operation 602, and/or an operation 604.

Operation 602 illustrates receiving at least one voluntary questionnaire. For example, as shown in FIG. 1, receiver module 102 may receive at least one voluntary questionnaire. In one example, receiver module 102 receives one thousand voluntary questionnaires from memory device 112. Voluntary questionnaires may include questionnaires including medical information, epigenetic information, and disability information as well as other information. In some instances, receiver module 102 may include a computer processor.

Operation 604 depicts receiving at least one of an individual health history or a family health history. For example, as shown in FIG. 1, receiver module 102 may receive at least one of an individual health history or a family health history. In an example, receiver module 102 receives an individual health history. An individual health history may include past diseases and/or illnesses, medication regiments and/or treatment regiments, and/or past health provider visits, as well as other occurrences relating to an individual's health. A family health history may include occurrences relating to the health of a certain family, including the occurrences of an illness and/or disease, a genetic predisposition to a certain disease, and/or other genetic traits. In some instances, receiver module 102 may include a computer processor.

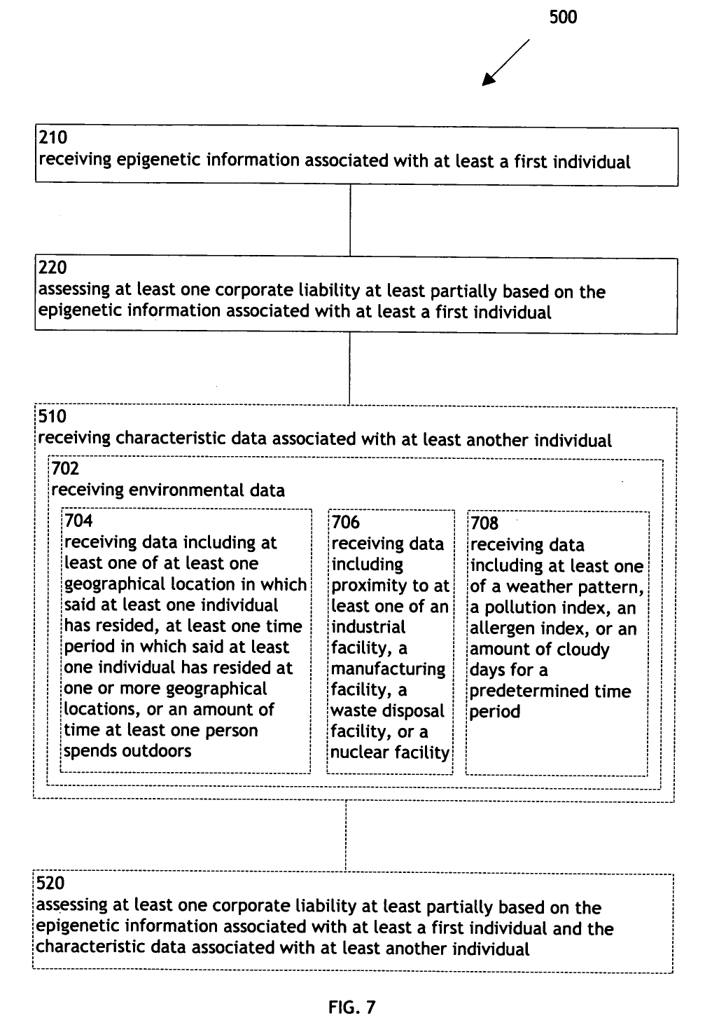

FIG. 7 illustrates alternative embodiments of the example operational flow 500 of FIG. 5. FIG. 7 illustrates example embodiments where operation 510 may include at least one additional operation. Additional operations may include an operation 702, an operation 704, an operation 706, and/or an operation 708.

Operation 702 illustrates receiving environmental data. For example, as shown in FIG. 1, receiver module 102 may receive environmental data. In one example, receiver module 102 receives environmental data including weather pattern data. Environmental data may include information that describes environmental processes, locations, conditions, and/or ecological or health effects and consequences. Further, operation 704 shows receiving data including at least one of at least one geographical location in which said at least one individual has resided, at least one time period in which said at least one individual has resided at one or more geographical locations, or an amount of time at least one person spends outdoors. For example, as shown in FIG. 1, receiver module 102 may receive data including at least one of at least one geographical location in which said at least one individual has resided, at least one time period in which said at least one individual has resided at one or more geographical locations, or an amount of time at least one person spends outdoors. In one example, receiver module 102 receives data including geographical locations in which an individual named Richard Cooper has resided for the last twenty years from database entry 114. Further, operation 706 illustrates receiving data including proximity to at least one of an industrial facility, a manufacturing facility, a waste disposal facility, or a nuclear facility. For example, as shown in FIG. 1, receiver module 102 may receive data including proximity to at least one of an industrial facility, a manufacturing facility, a waste disposal facility, or a nuclear facility. In one instance, receiver module 102 receives data including proximity to an industrial facility from database entry 114. An industrial facility may include a location, at least one building, a business, and/or a company configured to produce goods and/or services. A manufacturing facility may include a location where raw materials may be refined, and/or processed into a finished product. Some examples of an industrial facility and/or a manufacturing facility may include distribution facilities, warehouse facilities, a mine, a construction site, a farm, a power plant, and/or an oil refinery. A waste disposal facility may include any facility configured to store, process, or destroy waste. Examples of a waste disposal facility may include a sewage and/or water treatment plant, a landfill, and/or a nuclear waste disposal facility. Examples of a nuclear facility may include a nuclear waste disposal facility, nuclear reactors, laboratories engaged in nuclear research, and/or military facilities storing and/or using nuclear weapons. In some instances, receiver module 102 may include a computer processor. Further, operation 708 illustrates receiving data including at least one of a weather pattern, a pollution index, an allergen index, or an amount of cloudy days for a predetermined time period. For example, as shown in FIG. 1, receiver module 102 may receive data including at least one of a weather pattern, a pollution index, an allergen index, or an amount of cloudy days for a predetermined time period. In one instance, receiver module 102 receives data including a pollution index from compact disc storage 116. A pollution index may include a measurement of pollution in a geographic location. Examples of a pollution index may include an air pollution index, an air quality index, and/or a pollutants standard index. A weather pattern may include trends and/or repeats of atmospheric conditions, climate, temperatures, precipitation, storms, and/or movement of air. An allergen index may include a measurement of allergen amounts for a geographic location and/or area. Examples of allergens may include pollen, pet dander, dust, latex, nuts, insect stings, mold, and/or spores. An amount of cloudy days for a predetermined time period may include days having different degrees and/or designations of cloud cover, such as partly sunny, partly cloudy, etc. In some instances, receiver module 102 may include a computer processor.

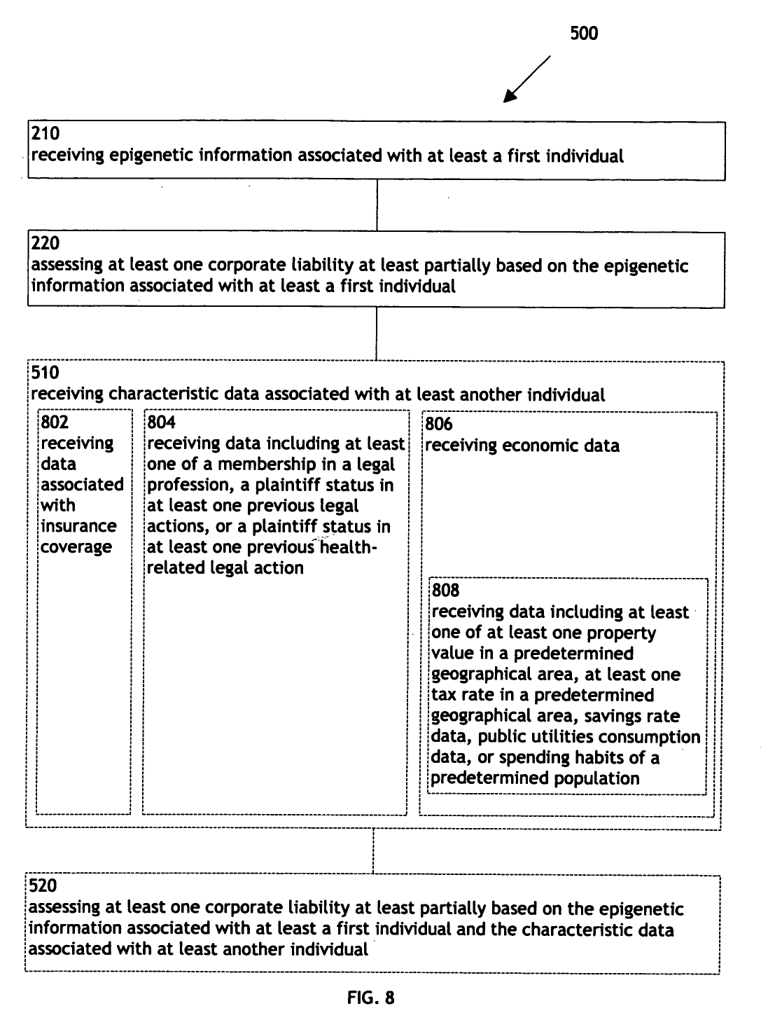

FIG. 8 illustrates alternative embodiments of the example operational flow 500 of FIG. 5. FIG. 8 illustrates example embodiments where operation 510 may include at least one additional operation. Additional operations may include an operation 802, an operation 804, an operation 806, and/or an operation 808.

Operation 802 depicts receiving data associated with insurance coverage. For example, as shown in FIG. 1, receiver module 102 may receive data associated with insurance coverage. In a specific example, receiver module 102 receives data associated with insurance coverage including health insurance from network storage 110. Examples of insurance coverage may include health insurance, life insurance, dental insurance, etc. In some instances, receiver module 102 may include a computer processor.

Operation 804 shows receiving data including at least one of a membership in a legal profession, a plaintiff status in at least one previous legal action, or a plaintiff status in at least one previous health-related legal action. For example, as shown in FIG. 1, receiver module 102 may receive data including at least one of a membership in a legal profession, a plaintiff status in at least one previous legal action, or a plaintiff status in at least one previous health-related legal action. In one instance, receiver module 102 receives data including membership in the California bar from database entry 114. A membership in a legal profession may include membership in a bar, association, fraternity and/or sorority, firm, and/or organization. A plaintiff status in a previous legal action and/or plaintiff status in a previous health-related action may include the outcome of a legal proceeding, trial, negotiation and/or arbitration. In some instances, receiver module 102 may include a computer processor.

Operation 806 illustrates receiving economic data. For example, as shown in FIG. 1, receiver module 102 may receive economic data. In an example, receiver module 102 receives economic data including income per capita for a city. Economic data may include data pertaining to the production, distribution, and use of income, wealth, and commodities. Further, operation 808 depicts receiving data including at least one of at least one property value in a predetermined geographical area, at least one tax rate in a predetermined geographical area, savings rate data, public utilities consumption data, or spending habits of a predetermined population. For example, as shown in FIG. 1, receiver module 102 may receive data including at least one of at least one property value in a predetermined geographical area, at least one tax rate in a predetermined geographical area, savings rate data, public utilities consumption data, or spending habits of a predetermined population. In an example, receiver module 102 receives data including a property tax rate in the state of Virginia from memory device 112. A property value may include land value, structure value, home value, and/or building value. Some examples of a tax rate may include rates for income tax, sales tax, property tax, consumption tax, gas tax, etc. Savings rate data may include the rate of money deposited in a passbook savings account and/or the rate of money deposited in a retirement account. Public utilities consumption data may include the rate of energy usage including electricity, natural gas, and/or water. The spending habits of a predetermined population may include examples such as retail sales and/or vehicle sales. In some instances, receiver module 102 may include a computer processor.

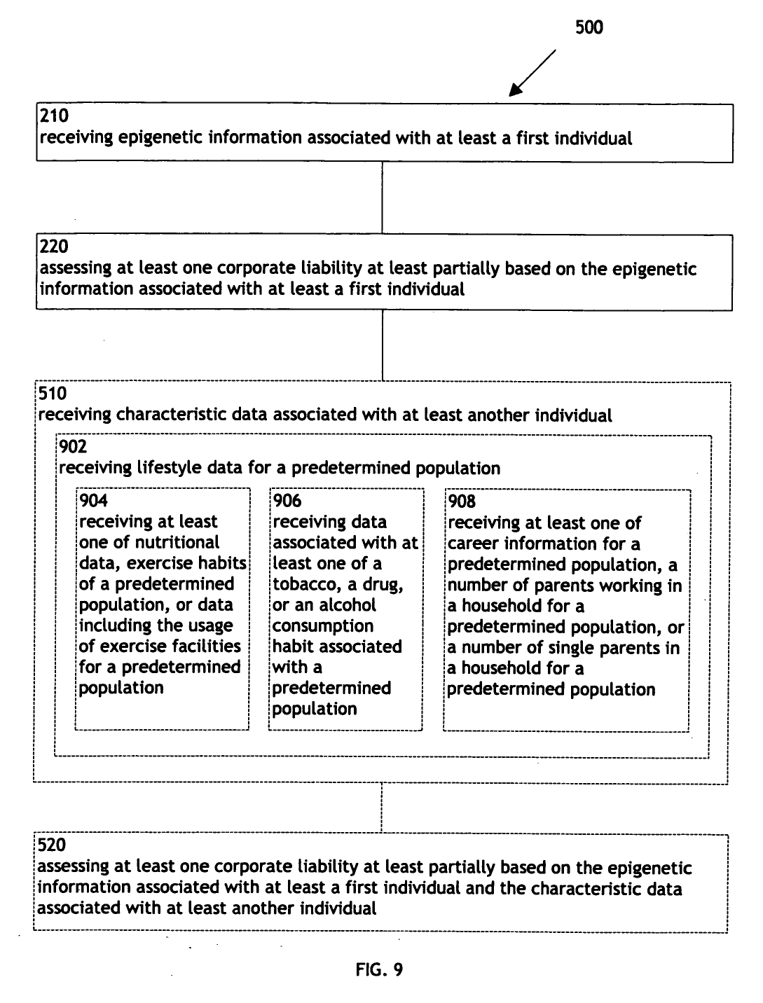

FIG. 9 illustrates alternative embodiments of the example operational flow 500 of FIG. 5. FIG. 9 illustrates example embodiments where operation 510 may include at least one additional operation. Additional operations may include an operation 902, an operation 904, an operation 906, and/or an operation 908.

Operation 902 illustrates receiving lifestyle data for a predetermined population. For example, as shown in FIG. 1, receiver module 102 may receive lifestyle data for a predetermined population. In a specific instance, receiver module 102 receives lifestyle data including food consumption data for the state of Maryland from database entry 114. Lifestyle data may include data related to habits, attitudes, economic level, moral standards, manner of living, fashions, and/or style for an individual and/or group. Further, operation 904 shows receiving at least one of nutritional data, exercise habits of a predetermined population, or data including the usage of exercise facilities for a predetermined population. For example, as shown in FIG. 1, receiver module 102 may receive at least one of nutritional data, exercise habits of a predetermined population, or data including the usage of exercise facilities for a predetermined population. In one instance, receiver module 102 receives data including the usage of exercise facilities for the city of Las Vegas, Nev. from compact disc storage 116. Nutritional data may include sales of certain food items, consumption of certain food items, and/or restaurant data. Exercise habits of a predetermined population may include sales data of exercise equipment and/or nutritional supplements, participation in athletic events, such as a marathon, and/or the number of exercise facilities within a geographical area and/or location. In some instances, receiver module 102 may include a computer processor. Further, operation 906 illustrates receiving data associated with at least one of a tobacco, a drug, or an alcohol consumption habit associated with a predetermined population. For example, as shown in FIG. 1, receiver module 102 may receive data associated with at least one of a tobacco, a drug, or an alcohol consumption habit associated with a predetermined population. In one example, receiver module 102 receives data regarding alcohol consumption habits associated with a certain county from network storage 110. Alcohol consumption habit data may include data regarding alcohol sales, the number of bars and/or nightclubs in a certain area, the rate of DUI stops in a certain location, and/or the number of Alcoholics Anonymous meetings. A tobacco habit may include tobacco sales for a geographic location. Data associated with a drug habit may include data including over-the-counter and/or prescription drug sales, doctor prescriptions, illegal drug arrests, and/or illegal drug convictions. In some instances, receiver module 102 may include a computer processor. Further, operation 908 shows receiving at least one of career information for a predetermined population, a number of working parents in a household for a predetermined population, or a number of single parents in a household for a predetermined population. For example, as shown in FIG. 1, receiver module 102 may receive at least one of career information for a predetermined population, a number of working parents in a household for a predetermined population, or a number of single parents in a household for a predetermined population. In a specific instance, receiver module 102 receives career information for the state of Illinois. Career information data may include unemployment rates, the types of industry, the amount of professionals, and or the average age of employees in a geographic area. In some instances, receiver module 102 may include a computer processor.

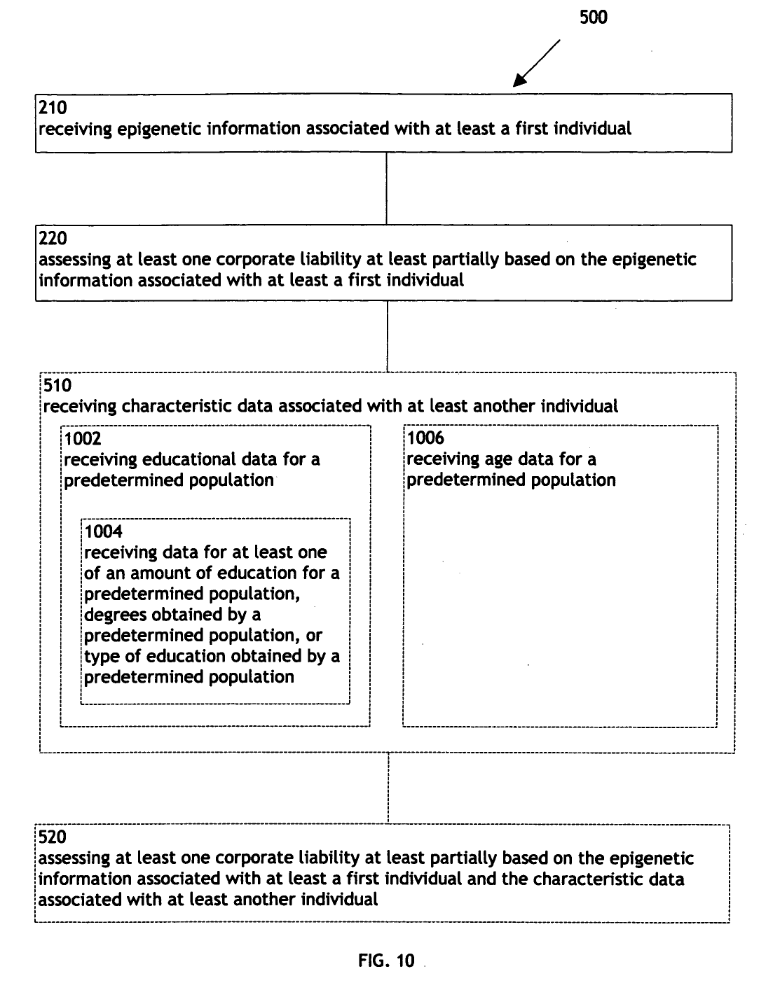

FIG. 10 illustrates alternative embodiments of the example operational flow 500 of FIG. 5. FIG. 10 illustrates example embodiments where operation 510 may include at least one additional operation. Additional operations may include an operation 1002, an operation 1004, and/or an operation 1006.

Operation 1002 illustrates receiving educational data for a predetermined population. For example, as shown in FIG. 1, receiver module 102 may receive educational data for a predetermined population. In one instance, receiver module 102 receives educational data including the level of education attained by residents in Washington D.C. from memory device 112. Examples of educational data may include the amount of education attained by a specific population, the degree, diploma, and/or certificate attained by a certain population, and/or the amount of students in a certain population. In some instances, receiver module 102 may include a computer processor. Further, operation 1004 depicts receiving data for at least one of an amount of education for a predetermined population, degrees obtained by a predetermined population, or type of education obtained by a predetermined population. For example, as shown in FIG. 1, receiver module 102 may receive data for at least one of an amount of education for a predetermined population, degrees obtained by a predetermined population, or type of education obtained by a predetermined population from network storage 110. In one instance, receiver module 102 receives data including the number of doctorate degrees obtained by the population of Connecticut. An amount of education may include an amount of time in an educational program and/or a level of education attained. An education degree may include a degree, a certificate, a diploma, and/or other measurements of educational levels. In some instances, receiver module 102 may include a computer processor.

Operation 1006 illustrates receiving age data for a predetermined population. For example, as shown in FIG. 1, receiver module 102 may receive age data for a predetermined population. In one example, receiver module 102 receives age data for the state of Florida from database entry 114. Age data may include the number of people over the age of majority, the number of people collecting retirement benefits, the number of retirement communities in a geographic location, and/or the number of minors in a geographic location. In some instances, receiver module 102 may include a computer processor.

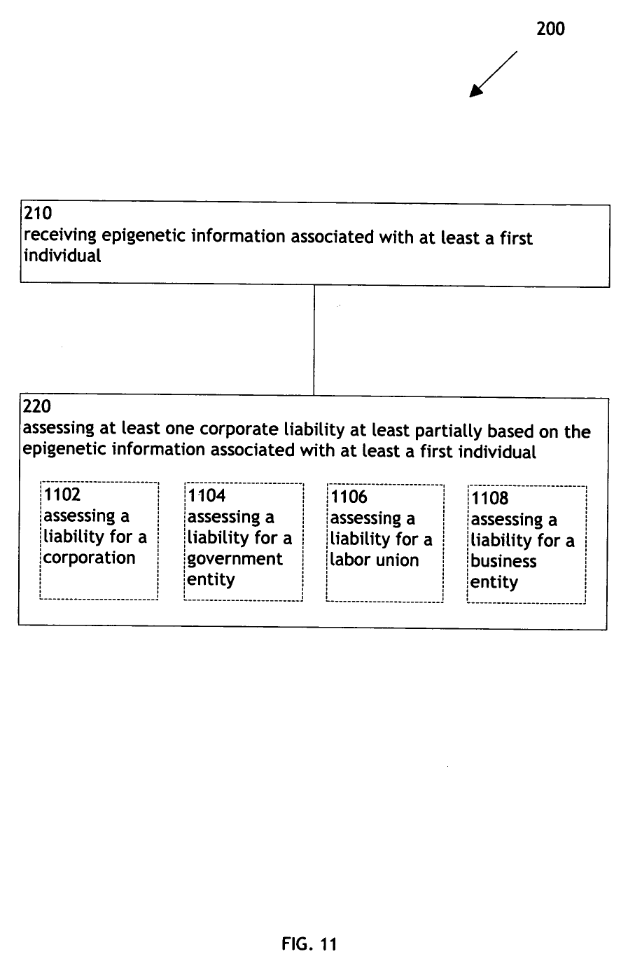

FIG. 11 illustrates alternative embodiments of the example operational flow 200 of FIG. 2. FIG. 11 illustrates example embodiments where operation 220 may include at least one additional operation. Additional operations may include an operation 1102, an operation 1104, an operation 1106, and/or an operation 1108.

Operation 1102 illustrates assessing a liability for a corporation. For example, as shown in FIG. 1, assessor module 104 may assess a liability for a corporation. In one example, assessor module 104 assesses a liability for a Fortune 500 corporation. A corporation may include a group of individuals and/or entities organized under law to be a single entity. In some instances, assessor module 104 may include a computer processor.

Operation 1104 shows assessing a liability for a government entity. For example, as shown in FIG. 1, assessor module 104 may evaluate a liability for a government entity. In a specific instance, assessor module 104 evaluates a liability for a state government. A government entity may include any agency, department or other instrumentality of federal, state or local government. In some instances, assessor module 104 may include a computer processor.

Operation 1106 illustrates assessing a liability for a labor union. For example, as shown in FIG. 1, assessor module 104 may assess a liability for a labor union. In one example, assessor module 104 assesses a liability for a local steelworkers union. Examples of a union may include any organization of workers, a trade union, American Federation of Labor and Congress of Industrial Organizations (AFL-CIO), International Association of Fire Fighters (IAFF), etc. In some instances, assessor module 104 may include a computer processor.

Operation 1108 depicts assessing a liability for a business entity. For example, as shown in FIG. 1, assessor module 104 may calculate a liability for a business entity. In one specific example, assessor module 104 calculates a liability for a large vehicle manufacturer. A business entity may include an organization which provides goods and/or services. In some instances, assessor module 104 may include a computer processor.

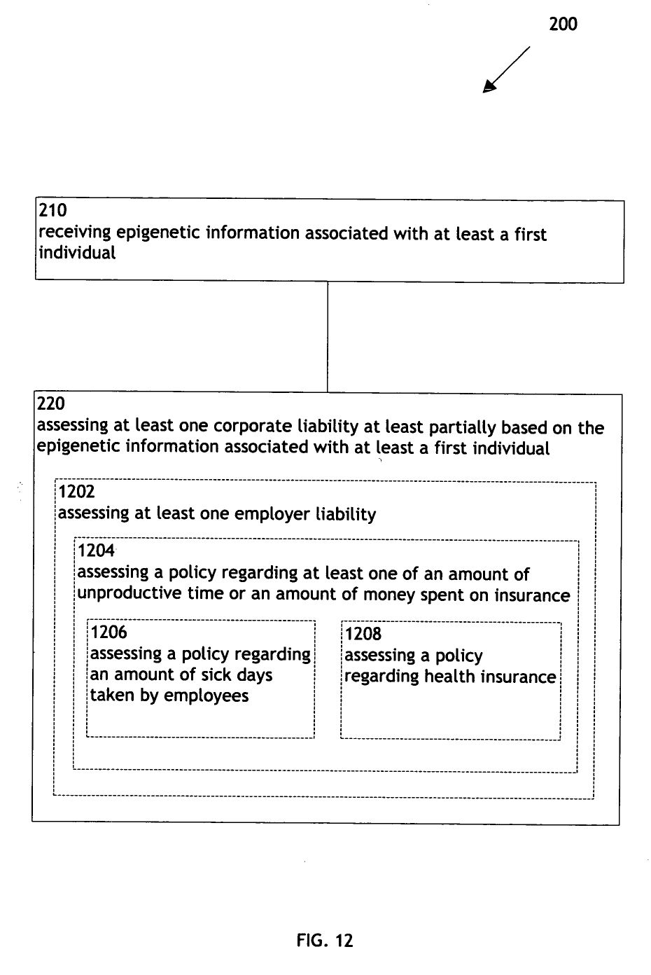

FIG. 12 illustrates alternative embodiments of the example operational flow 200 of FIG. 2. FIG. 12 illustrates example embodiments where operation 220 may include at least one additional operation. Additional operations may include an operation 1202, an operation 1204, an operation 1206, and/or an operation 1208.

Operation 1202 shows assessing at least one employer liability. For example, as shown in FIG. 1, assessor module 104 may assess at least one employer liability. In a specific instance, assessor module 104 assesses a pension plan including providing health and prescription medication. An employer liability may include pension plans, retirement plans, and/or obligations to pay health care costs. In some instances, assessor module 104 may include a computer processor. Further, operation 1204 illustrates assessing a policy regarding at least one of an amount of unproductive time or an amount of money spent on insurance. For example, as shown in FIG. 1, assessor module 104 may assess a policy regarding at least one of an amount of unproductive time or an amount of money spent on insurance. In one example, assessor module 104 assesses a policy regarding an amount of unproductive time including time employees do not work because of illness. Unproductive time may include time taken off due to sickness and/or illness, vacation time, or inefficient performance due to illness and/or sickness. An amount of money spent on insurance may include health insurance, disability insurance, unemployment insurance, and/or life insurance. In some instances, assessor module 104 may include a computer processor. Further, operation 1206 shows assessing a policy regarding an amount of sick days taken by employees. For example, as shown in FIG. 1, assessor module 104 may evaluate a policy regarding an amount of sick days taken by employees. In one instance, assessor module 104 evaluates a policy regarding an amount of sick days taken by employees. Sick days taken by employees may include days taken off for illness, dentist visits, minor surgeries, diabetes care, and/or illness of dependents. In some instances, assessor module 104 may include a computer processor. Further, operation 1208 depicts assessing a policy regarding health insurance. For example, as shown in FIG. 1, assessor module 104 may assess a policy regarding health insurance. In one example, assessor module 104 assesses a policy regarding health insurance. A policy regarding health insurance may include any policy providing for protection against financial loss from a personal accident, disease and/or illness. In some instances, assessor module 104 may include a computer processor.

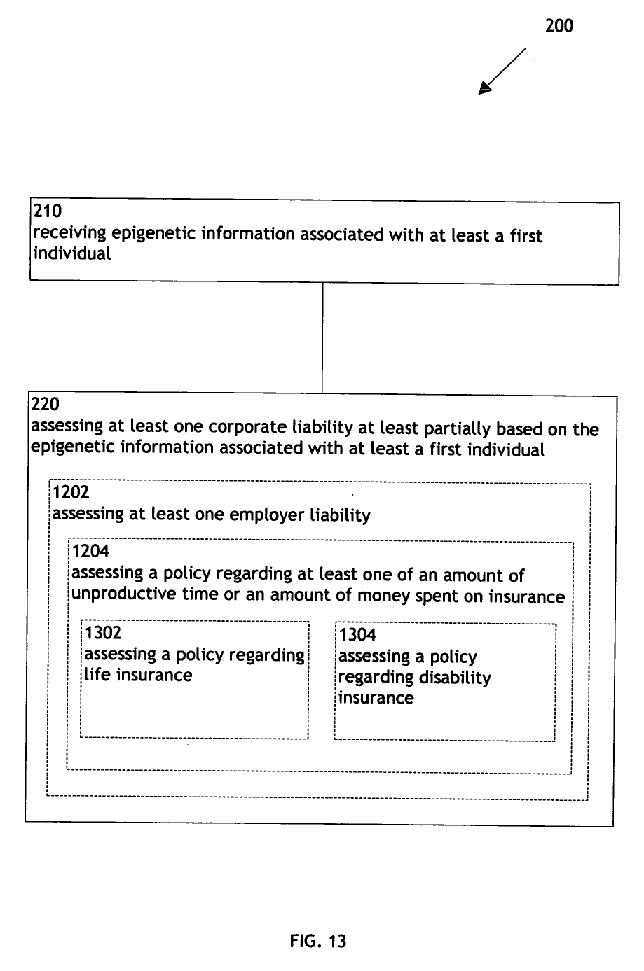

FIG. 13 illustrates alternative embodiments of the example operational flow 200 of FIG. 2. FIG. 13 illustrates example embodiments where operation 220 may include at least one additional operation. Additional operations may include an operation 1302, and/or an operation 1304. Further, operation 1302 illustrates assessing a policy regarding life insurance. For example, as shown in FIG. 1, assessor module 104 may appraise a policy regarding life insurance. In a specific example, assessor module 104 appraises a company policy regarding life insurance and the premium amount for a specific death benefit amount for each employee. In some instances, assessor module 104 may include a computer processor. A life insurance policy may include insurance that provides for the payment of a benefit upon the death of the insured person. Further, operation 1304 illustrates assessing a policy regarding disability insurance. For example, as shown in FIG. 1, assessor module 104 may assess a policy regarding disability insurance. In one instance, assessor module 104 assesses a corporate policy regarding disability insurance including the premium for group disability insurance coverage. A disability insurance policy may include a policy that provides income benefits to the insured if the insured becomes ill and/or is injured and can no longer work. In some instances, assessor module 104 may include a computer processor.

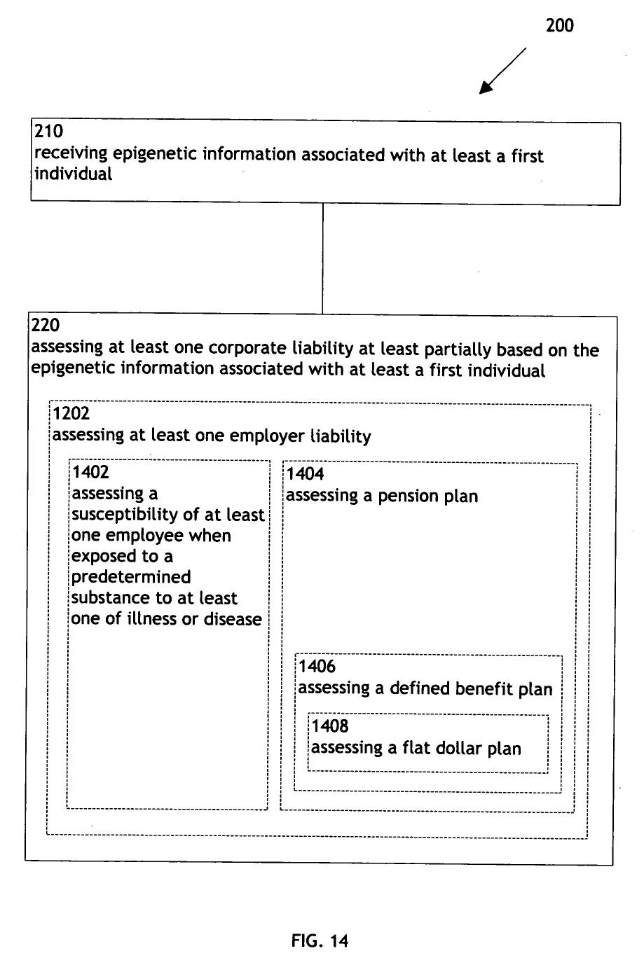

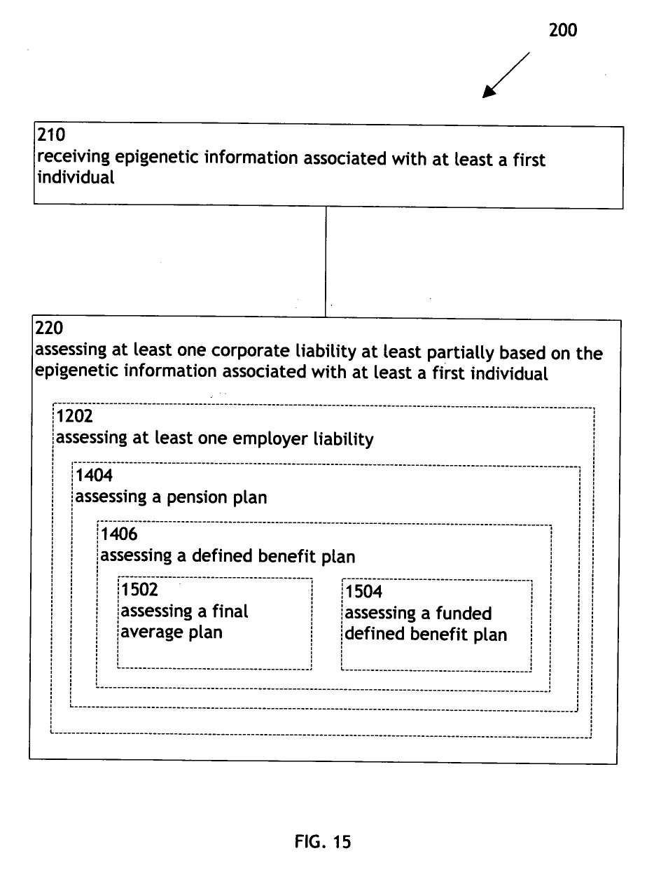

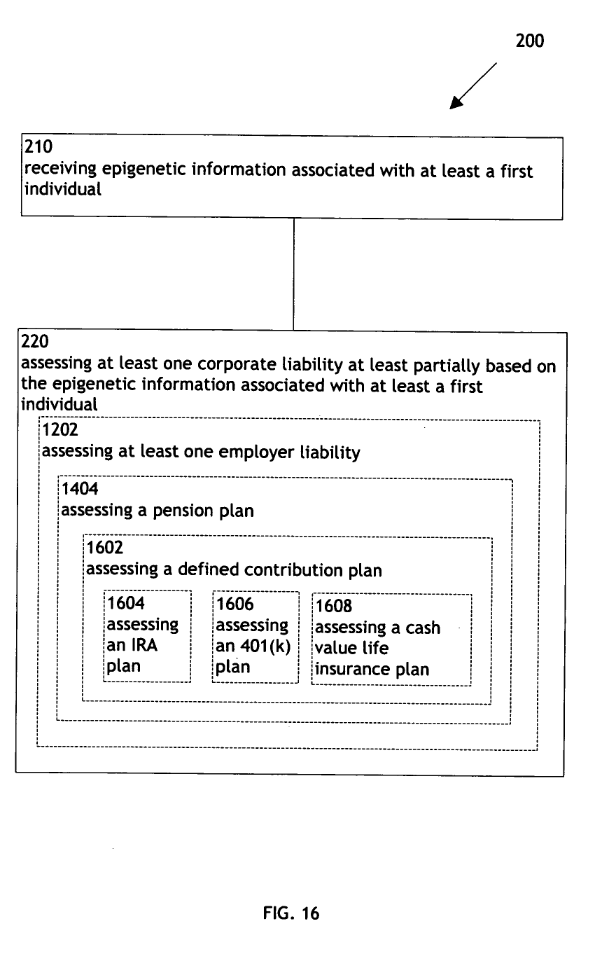

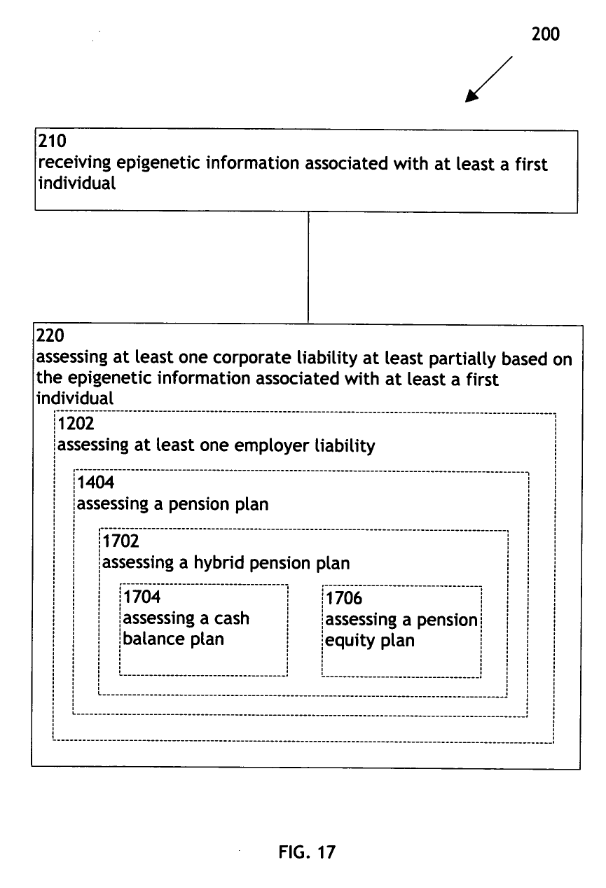

FIG. 14 illustrates alternative embodiments of the example operational flow 200 of FIG. 2. FIG. 14 illustrates example embodiments where operation 220 may include at least one additional operation. Additional operations may include an operation 1402, an operation 1404, an operation 1406, and/or an operation 1408. Further, operation 1402 illustrates assessing a susceptibility of at least one employee when exposed to a predetermined substance to at least one of illness or disease. For example, as shown in FIG. 1, assessor module 104 may evaluate a susceptibility of at least one employee when exposed to a predetermined substance to at least one of illness or disease. In one example, assessor module 104 evaluates susceptibility to illness for employees of a certain corporation when exposed to janitorial cleaning supplies. Susceptibility may include the lack of resistance to disease and/or the degree to which a person is sensitive to a remedy or a disease. In some instances, assessor module 104 may include a computer processor. Further, operation 1404 shows assessing a pension plan. For example, as shown in FIG. 1, assessor module 104 may assess a pension plan. In one instance, assessor module 104 assesses a pension plan for a large airline corporation. A pension may include a steady benefit given to a person. The pension may or may not be after retirement. Examples of a pension may include income and insurance benefits. In some instances, assessor module 104 may include a computer processor. Further, operation 1406 depicts assessing a defined benefit plan. For example, as shown in FIG. 1, assessor module 104 may evaluate a defined benefit plan. In a specific example, assessor module 104 evaluates a defined benefit plan including a health insurance benefit. A defined benefit plan may include a pension plan that defines a benefit for an employee upon that employee's retirement. In a defined benefit plan, a formula may be utilized for determining the benefit received by the employee. In some instances, assessor module 104 may include a computer processor. Further, operation 1408 illustrates assessing a flat dollar plan. For example, as shown in FIG. 1, assessor module 104 may review a flat dollar plan. In one example assessor module 104 reviews a flat dollar plan. A flat dollar plan may include a type of defined benefit plan that provides a certain amount of a benefit, such as income, for a certain amount of time employed by an employer. In one example of a flat dollar plan, a company provides $100 per month for every year an employee works for a company. In the same example, the employee works for the company for 20 years and receives $2000 per month. In some instances, assessor module 104 may include a computer processor.

FIG. 15 illustrates alternative embodiments of the example operational flow 200 of FIG. 2. FIG. 15 illustrates example embodiments where operation 220 may include at least one additional operation. Additional operations may include an operation 1502, and/or an operation 1504. Further, operation 1502 illustrates assessing a final average plan. For example, as shown in FIG. 1, assessor module 104 may assess a final average plan. In a specific example, assessor module 104 assesses a final average plan. A final average plan may include a plan where the average compensation over the last three or five years of an employee's career determines a benefit received by the employee. In some instances, assessor module 104 may include a computer processor. Further, operation 1504 depicts assessing a funded defined benefit plan. For example, as shown in FIG. 1, assessor module 104 may evaluate a funded defined benefit plan. In one instance, assessor module 104 evaluates a funded defined benefit plan. A funded defined benefit plan may include a plan where an actuary may calculate the contributions a plan sponsor must make to ensure the pension fund will be able to meet future payment obligations, and the risk may be assumed by the employer and/or plan sponsor. In some instances, assessor module 104 may include a computer processor.

FIG. 16 illustrates alternative embodiments of the example operational flow 200 of FIG. 2. FIG. 16 illustrates example embodiments where operation 220 may include at least one additional operation. Additional operations may include an operation 1602, an operation 1604, an operation 1606, and/or an operation 1608. Further, operation 1602 shows assessing a defined contribution plan. For example, as shown in FIG. 1, assessor module 104 may assess a defined contribution plan. A defined contribution plan may include a plan providing for an individual account for each participant, and for benefits based solely on the amount contributed to the account, plus or minus income, gains, expenses and losses allocated to the account. In a specific example, assessor module 104 assesses a defined contribution plan including a 401(k) plan. Examples of defined contribution plan may include 401(k) plans, IRA plans, and/or SIMPLE IRA plans. Additionally, the employer may or may not match contributions to the plan. In some instances, assessor module 104 may include a computer processor. Further, operation 1604 shows assessing an IRA plan. For example, as shown in FIG. 1, assessor module 104 may evaluate an IRA plan. An IRA plan may include an individual retirement arrangement, an individual retirement annuity, and/or a simplified employee pension (SEP). Examples of an IRA may include a traditional IRA, a Roth IRA, a SEP IRA, a SIMPLE IRA, and/or a Self-Directed IRA. In a specific example, assessor module 104 evaluates an IRA plan including a traditional IRA plan in which a corporate employer matches employee contributions up to 3%. In some instances, assessor module 104 may include a computer processor. Further, operation 1606 depicts assessing a 401(k) plan. For example, as shown in FIG. 1, assessor module 104 may assess a 401(k) plan. A 401(k) plan may include a type of employer-sponsored retirement plan in the United States under section 401(k) of the Internal Revenue Code. A 401(k) plan may allow a worker to save for retirement while deferring income taxes on the saved money and earnings until withdrawal. In one instance, assessor module 104 assesses a 401(k) plan provided to employees by an employer. In some instances, assessor module 104 may include a computer processor. Further, operation 1608 illustrates assessing a cash value life insurance plan. For example, as shown in FIG. 1, assessor module 104 may assess a cash value life insurance plan. A cash value life insurance plan may include life insurance policy that builds a cash value that reduces the amount at risk to the insurance company and thus the insurance expense over time. In some cash value life insurance plans, the policy owner may access the money in the cash value by withdrawing money, borrowing the cash value, or surrendering the policy and receiving the surrender value. In one example, assessor module 104 assesses a cash value life insurance plan provided by a corporate employer where the employee's account balance in the plan grows by a defined rate of interest and the annual employer contribution. In some instances, assessor module 104 may include a computer processor.

FIG. 17 illustrates alternative embodiments of the example operational flow 200 of FIG. 2. FIG. 17 illustrates example embodiments where operation 220 may include at least one additional operation. Additional operations may include an operation 1702, an operation 1704, and/or an operation 1706. Further, operation 1702 depicts assessing a hybrid pension plan. For example, as shown in FIG. 1, assessor module 104 may evaluate a hybrid pension plan. A hybrid pension plan may include a plan with both the features of a defined benefit plan and a defined contribution plan. In a specific example, assessor module 104 evaluates a hybrid pension plan. In some instances, assessor module 104 may include a computer processor. Further, operation 1704 illustrates assessing a cash balance plan. For example, as shown in FIG. 1, assessor module 104 may assess a cash balance plan. A cash balance plan may include a plan where the employer contributes money to an account available to the employee upon retirement. In one instance, assessor module 104 assesses a cash balance plan. In some instances, assessor module 104 may include a computer processor. Further, operation 1706 illustrates assessing a pension equity plan. For example, as shown in FIG. 1, assessor module 104 may assess a pension equity plan. A pension equity plan may include the guaranteed benefits of a defined benefit plan while expressing benefits in terms of a current lump sum. A pension equity plan may be advantageous because mobile employees retain access to the benefits offered by the plan, even when the employee leaves their employer. In a specific instance, assessor module 104 assesses a pension equity plan including a cash lump sum benefit. In some instances, assessor module 104 may include a computer processor.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link (e.g., transmitter, receiver, transmission logic, reception logic, etc.), a wireless communication link, etc.).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art wilt recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at Least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms. For example, the phrase “A or B” will be typically understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A computer-implemented method, comprising:
receiving epigenetic information associated with at least a first individual; and
assessing at least one corporate liability at least partially based on the epigenetic information associated with at least a first individual.

2-52. (canceled)

53. A system, comprising:
means for receiving epigenetic information associated with at least a first individual; and
means for assessing at least one corporate liability at least partially based on the epigenetic information associated with at least a first individual.

54. The system of claim 53, wherein means for receiving epigenetic information associated with at least a first individual comprises:
means for receiving the epigenetic information associated with at least a first individual in the form of a database.

55. The system of claim 53, wherein means for receiving epigenetic information associated with at least a first individual comprises:
means for receiving a first set of the epigenetic information associated with at least a first individual; and
means for receiving a second set of the epigenetic information associated with at least a first individual.

56. The system of claim 55, further comprising:
means for receiving a third set of the epigenetic information associated with at least a first individual.

57. The system of claim 53, wherein means for receiving epigenetic information associated with at least a first individual comprises:
means for receiving information including a cytosine methylation status of CpG positions.

58. The system of claim 53, wherein means for receiving epigenetic information associated with at least a first individual comprises:
means for receiving information including histone modification status.

59. The system of claim 53, wherein means for receiving epigenetic information associated with at least a first individual comprises:
means for receiving the epigenetic information associated with at least a first individual on a subscription basis.

60. The system of claim 53, wherein means for receiving epigenetic information associated with at least a first individual comprises:
means for receiving anonymized epigenetic information associated with at least a first individual.

61. The system of claim 60, wherein means for receiving anonymized epigenetic information associated with at least a first individual comprises:
means for receiving the epigenetic information associated with at least a first individual for at least a second individual.

62. The system of claim 53, further comprising:
means for receiving characteristic data associated with at least another individual; and
means for assessing at least one corporate liability at least partially based on the epigenetic information associated with at least a first individual and the characteristic data associated with at least another individual.

63. The system of claim 62, wherein means for receiving characteristic data associated with at least another individual comprises:
means for receiving public health information.

64-65. (canceled)

66. The system of claim 62, wherein means for receiving characteristic data associated with at least another individual comprises:
means for receiving at least one of an individual health history or a family health history.

67. The system of claim 62, wherein means for receiving characteristic data associated with at least another individual comprises:
means for receiving environmental data.

68. The system of claim 67, wherein means for receiving environmental data comprises:
means for receiving data including at least one of at least one geographical location in which said at least one individual has resided, at least one time period in which said at least one individual has resided at one or more geographical locations, or an amount of time at least one person spends outdoors.

69. The system of claim 67, wherein means for receiving environmental data comprises:
means for receiving data including proximity to at least one of an industrial facility, a manufacturing facility, a waste disposal facility, or a nuclear facility.

70. (canceled)

71. The system of claim 62, wherein means for receiving characteristic data associated with at least another individual comprises:
means for receiving data associated with insurance coverage.

72. The system of claim 62, wherein means for receiving characteristic data associated with at least another individual comprises:
means for receiving data including at least one of a membership in a legal profession, a plaintiff status in at least one previous legal action, or a plaintiff status in at least one previous health-related legal action.

73. The system of claim 62, wherein means for receiving characteristic data associated with at least another individual comprises:
means for receiving economic data.

74. (canceled)

75. The system of claim 62, wherein means for receiving characteristic data associated with at least another individual comprises:
means for receiving lifestyle data for a predetermined population.

76. The system of claim 75, wherein means for receiving lifestyle data for a predetermined population comprises:
means for receiving at least one of nutritional data, exercise habits of a predetermined population, or data including the usage of exercise facilities for a predetermined population.

77-78. (canceled)

79. The system of claim 62, wherein means for receiving characteristic data associated with at least another individual comprises:
means for receiving educational data for a predetermined population.

80. (canceled)

81. The system of claim 62, wherein means for receiving characteristic data associated with at least another individual comprises:
means for receiving age data for a predetermined population.

82. The system of claim 53, wherein means for assessing at least one corporate liability at least partially based on the epigenetic information associated with at least a first individual comprises:
means for assessing a liability for a corporation.

83-84. (canceled)

85. The system of claim 53, wherein means for assessing at least one corporate liability at least partially based on the epigenetic information associated with at least a first individual comprises:
means for assessing a liability for a business entity.

86. The system of claim 53, wherein means for assessing at least one corporate liability at least partially based on the epigenetic information associated with at least a first individual comprises:
means for assessing at least one employer liability.

87-88. (canceled)

89. The system of claim 87, wherein means for assessing a policy regarding at least one of an amount of unproductive time or an amount of money spent on insurance comprises:
means for assessing a policy regarding health insurance.

90. The system of claim 87, wherein means for assessing a policy regarding at least one of an amount of unproductive time or an amount of money spent on insurance comprises:
means for assessing a policy regarding life insurance.

91-92. (canceled)

93. The system of claim 86, wherein means for assessing at least one employer liability comprises:
means for assessing a pension plan.

94. The system of claim 93, wherein means for assessing a pension plan comprises:
means for assessing a defined benefit plan.

95-97. (canceled)

98. The system of claim 93, wherein means for assessing a pension plan comprises:
means for assessing a defined contribution plan.

99-101. (canceled)

102. The system of claim 93, wherein means for assessing a pension plan comprises:
means for assessing a hybrid pension plan.

103-104. (canceled)

105. A system, comprising:
circuitry for receiving epigenetic information associated with at least a first individual; and
circuitry for assessing at least one corporate liability at least partially based on the epigenetic information associated with at least a first individual.
